(19) United States
(12) Patent Application Publication
(10) Pub. No.: US 2013/0129906 A1
(43) Pub. Date: May 23, 2013

(54) MEAT AGING COMPOSITION USING MULBERRY AND MEAT AGING METHOD USING THE SAME

(71) Applicant: DASO FOOD CO., LTD., Jeollanam (KR)

(72) Inventor: Jeong Gu Oh, Jeollanam-do (KR)

(73) Assignee: DASO FOOD CO., LTD., Jeollanam-do (KR)

(21) Appl. No.: 13/678,733

(22) Filed: Nov. 16, 2012

(30) Foreign Application Priority Data
Nov. 18, 2011 (KR) 10-2011-0120881

(51) Int. Cl. A23L 1/318

(52) U.S. Cl. CPC A23L 1/3182
USPC 426/652; 426/418

(57) ABSTRACT

Disclosed are a meat aging composition and a meat aging method using same. The meat aging composition, which includes 1-25 wt % of a Cudrania tricuspidata bark extract, 10-30 wt % of a Cudrania tricuspidata leaf extract and 20-60 wt % of a Cudrania tricuspidata fruit extract, can improve taste and chewiness of meat by tenderizing the meat, lower cholesterol, improve storage property of the meat and cure hangover and protect the liver when the meat is eaten with liquor.

### TECHNICAL FIELD

The present disclosure relates to a meat aging composition that improves taste and chewiness of meat by tenderizing meat, reduces cholesterol and improves storage property of meat and a meat aging method using same.

### BACKGROUND

One kind of Cudrania tricuspidata, Cudrania tricuspidata is a deciduous tree in the family Moraceae.

Since the root bark, woody part, bark and leaves of Cudrania tricuspidata contain various ingredients useful for the human body, they have been used as to lower blood pressure, treat tuberculosis, alleviate fever, help urination, stop bleeding, or the like.

In addition, Cudrania tricuspidata is used for patients who cannot receive chemotherapy or radiation therapy. In those patients, it inhibits tumor growth or reduces tumors, alleviates pain and improves appetite.

Although there have been efforts to use Cudrania tricuspidata in foods, they were not successful owing to the repulsive odor characteristic of Cudrania tricuspidata.

As an example of using Cudrania tricuspidata in food, Korean Patent Publication No. 2011-0006556 discloses kimchi prepared using a Cudrania tricuspidata extract prepared from powdered twigs or leaves of Cudrania tricuspidata. However, the kimchi prepared using Cudrania tricuspidata has unpleasant taste and flavor after aging.

Meanwhile, as meat consumption increases recently, meat is tenderized by a physical method of repeating freezing and thawing or a chemical method of adding a low-molecular-weight polyol-based chemical additive to provide softened meat. However, the meat tenderized by the physical method tends to be discolored or have worse quality and the chemical additive may cause a stability problem even with a small amount.

Therefore, meat tenderizing techniques using natural products have been developed.

For example, Korean Patent No. 466003 discloses a meat tenderizer using kiwi and fig, Korean Patent No. 154613 discloses a meat tenderizer prepared using a crude enzyme extracted from the fruit of paper Cudrania tricuspidata, and Korean Patent Publication No. 2010-0082681 discloses a meat tenderizer prepared using plum fruit, quince fruit and maple. However, these meat tenderizers cannot reduce cholesterol and cannot be used for a long period of time.

Accordingly, a meat aging composition using natural products containing a large amount of ingredients beneficial for human health and capable of, for example, reducing cholesterol, tenderizing meat, improving taste and chewiness of meat and improving storage property of meat is needed.

### SUMMARY

The present disclosure is directed to providing a meat aging composition using bark, leaves and fruits of Cudrania tricuspidata and capable of tenderizing meat, improving taste and chewiness of meat and improving storage property of meat.

The present disclosure is also directed to providing a meat aging method using the meat aging composition.

In one general aspect, there is provided a meat aging composition including 1-25 wt % of a Cudrania tricuspidata bark extract, 10-30 wt % of a Cudrania tricuspidata leaf extract and 20-60 wt % of a Cudrania tricuspidata fruit extract.

The Cudrania tricuspidata bark extract, the Cudrania tricuspidata leaf extract and the Cudrania tricuspidata fruit extract may be mixed with a weight ratio of 1:1:2.

The meat aging composition may further include 5-25 wt % of a fermented broth of shiitake and 1-20 wt % of licorice, and may further include 1-10 parts by weight of chitosan and 1-10 parts by weight of onion based on 100 parts by weight of the meat aging composition.

The Cudrania tricuspidata bark extract, the Cudrania tricuspidata leaf extract and the Cudrania tricuspidata fruit extract may be extracted respectively from Cudrania tricuspidata bark, Cudrania tricuspidata leaves and Cudrania tricuspidata fruit steamed and dried nine times and the fermented broth of shiitake may be fermented using Bacillus subtilis and Acetobacter aceti.

In another general aspect, there is provided a meat aging method including: preparing a meat aging composition by mixing 1-25 wt % of a Cudrania tricuspidata bark hot water extract, 10-30 wt % of a Cudrania tricuspidata leaf hot water extract and 20-60 wt % of a Cudrania tricuspidata fruit hot water extract and allowing the mixture to stand for 3-5 hours; and performing aging at −1 to 5° C. for 24-48 hours by mixing the meat aging composition and meat with a volume ratio of 1:1 to 1:3.

The Cudrania tricuspidata bark extract, the Cudrania tricuspidata leaf extract and the Cudrania tricuspidata fruit extract may be mixed with a weight ratio of 1:1:2.

The meat aging composition may further include 5-25 wt % of a fermented broth of shiitake and 1-20 wt % of licorice.

The meat aging method may further include, before preparing the meat aging composition, steaming and drying Cudrania tricuspidata bark, Cudrania tricuspidata leaves and Cudrania tricuspidata fruit nine times, washing the Cudrania tricuspidata bark, Cudrania tricuspidata leaves and Cudrania tricuspidata fruit steamed and dried nine times with distilled water and then pulverizing, and heating the pulverized Cudrania tricuspidata bark, Cudrania tricuspidata leaves and Cudrania tricuspidata fruit in hot water of 100-130° C. for 1-3 hours to obtain a hot water extract.

The meat aging method may further include, after the aging, performing aging at −1 to 5° C. for 1-4 hours by adding 1-10 parts by weight of chitosan and 1-10 parts by weight of onion based on 100 parts by weight of the meat aging composition to the aged meat.

The fermented broth of shiitake may be prepared by performing fermentation at 45-55° C. for 30-60 hours by mixing 10-30 wt % of shiitake, 5-20 wt % of brown sugar, 1-4 wt % of Bacillus subtilis and 60-70 wt % of purified water and performing fermentation at 25-35° C. for 20-40 days by adding 1-4 parts by weight of Acetobacter aceti based on 100 parts by weight of the fermented broth.

Other features and aspects will be apparent from the following detailed description, drawings and claims.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The present disclosure relates to a meat aging composition using Cudrania tricuspidata, for example, bark, leaves and fruit of Cudrania tricuspidata, which improves taste and chewiness of meat by tenderizing the meat, lowers cholesterol and improves storage property of the meat, and a meat aging method using same.

Hereinafter, exemplary embodiments of the present disclosure will be described in detail.

A meat aging composition of the present disclosure comprises 1-25 wt % of a Cudrania tricuspidata bark hot water extract, 10-30 wt % of a Cudrania tricuspidata leaf hot water extract and 20-60 wt % of a Cudrania tricuspidata fruit hot water extract. The meat aging composition may further comprise 5-25 wt % of a fermented broth of shiitake and 1-20 wt % of licorice and may further comprise 1-10 parts by weight of chitosan and 1-10 parts by weight of onion based on 100 parts by weight of the meat aging composition.

The Cudrania tricuspidata bark extract purifies blood, tenderizes meat and sweetens the meat.

The Cudrania tricuspidata bark extract may be included in an amount of 1-25 wt %, specifically 5-20 wt %. If the content of the Cudrania tricuspidata bark extract is less than 1 wt %, the meat may not be tenderized and taste may be poor. And, if the content exceeds 20 wt %, the meat may be tough.

The Cudrania tricuspidata leaf extract has hangover-curing, aging-preventing, meat-tenderizing and obesity-preventing effects and may be included in an amount of 10-30 wt %, specifically 15-25 wt %.

If the content is less than 10 wt %, the meat may not be tenderized. And, if the content exceeds 30 wt %, the meat may taste bitter and may not be tenderized enough.

The Cudrania tricuspidata fruit extract has kidney-strengthening, meat-tenderizing, obesity-preventing, sweetening, stench-removing and flavoring effects and may be included in an amount of 20-60 wt %, specifically 30-50 wt %.

If the content is less than 20 wt %, taste may be poor and the meat may not be tenderized. And, if the content exceeds 60 wt %, the meat may taste too sweet and may be tough.

The Cudrania tricuspidata bark extract, the Cudrania tricuspidata leaf extract and the Cudrania tricuspidata fruit extract may be mixed with a weight ratio of 1:1:2. Outside the weight ratio, the meat may not be tenderized, may be tough and may taste poor. Also, the lowering of cholesterol may be limited.

The Cudrania tricuspidata bark extract, the Cudrania tricuspidata leaf extract and the Cudrania tricuspidata fruit extract may be prepared using bark, leaves and fruit of Cudrania tricuspidata steamed and dried nine times for improvement of meat-tenderizing effect, prevention of obesity, improvement of taste, removal of characteristic odor of Cudrania tricuspidata bark and leaves and improvement of flavor.

The fermented broth of shiitake is more effective for arteriosclerosis, diabetes and cholelithiasis by lowering cholesterol as compared to shiitake itself and removes stent of meat and adds flavor and taste with its characteristic flavor and taste.

The composition of the present disclosure comprising the fermented broth of shiitake in addition to the Cudrania tricuspidata bark extract, the Cudrania tricuspidata leaf extract and the Cudrania tricuspidata fruit extract may lower cholesterol, tenderize meat and improve taste and flavor.

The fermented broth of shiitake may be included in an amount of 5-25 wt %, specifically 10-20 wt %. If the content of the fermented broth of shiitake is less than 5 wt %, the lowering of cholesterol may be limited. And, if it exceeds 25 wt %, taste may be poor and stomachache may be induced.

The fermented broth of shiitake may be prepared by performing fermentation at 45-55° C. for 30-60 hours by mixing 10-30 wt % of shiitake, 5-20 wt % of brown sugar, 1-4 wt % of Bacillus subtilis and 60-70 wt % of purified water and performing fermentation at 25-35° C. for 20-40 days by adding 1-4 parts by weight of Acetobacter aceti based on 100 parts by weight of the fermented broth.

For the preparation of the fermented broth of shiitake, the brown sugar may be included in an amount of 5-20 wt %, specifically 10-15 wt %. If the content of the brown sugar is less than 5 wt %, fermentation and tenderization of meat may not be accomplished. And, if it exceeds 20 wt %, fermentation and tenderization of meat may not occur as desired.

The Bacillus subtilis may be included in an amount of 1-4 wt %. If the content of the Bacillus subtilis is less than 1 wt %, it takes a long time for the fermentation. And, if it exceeds 4 wt %, the meat may be toughened and chewiness may be poor owing to excessive fermentation.

The Acetobacter aceti may be included in an amount of 1-4 parts by weight based on 100 parts by weight of the primarily fermented broth. If the content is less than 1 part by weight based on 100 parts by weight of the primarily fermented broth, lowering of cholesterol may be limited. And, if it exceeds 4 parts by weight, the meat may be toughened and chewiness may be poor owing to excessive fermentation.

Outside the fermentation temperature and time ranges, the meat may not be tenderized and chewiness may be poor.

The licorice harmonizes with other ingredients to improve the cholesterol-lowering and meat-tenderizing effects, sweetens the meat and helps digestion. It may be included in an amount of 1-20 wt %, specifically 5-15 wt %. If the content of the licorice is less than 1 wt %, improvement of the cholesterol-lowering and meat-tenderizing effects may be limited. And, if it exceeds 20 wt %, the meat may be toughened.

The meat aging composition of the present disclosure may further comprise chitosan and onion.

Chitosan lowers cholesterol. Since it is absorbed easily via enzymatic action, it facilitates tenderization of meat when used together with the fermented broth of shiitake.

The chitosan may be included in an amount of 1-10 parts by weight, specifically 1-7 parts by weight based on 100 parts by weight of the meat aging composition. If the content of the chitosan is less than 1 part by weight, the lowering of cholesterol may be limited and meat may not be tenderized. And, if it exceeds 10 parts by weight, chewiness may be poor owing to decreased elasticity of meat.

Onion lowers cholesterol, removes the stench of meat and provides sweetness. It may be included in an amount of 1-10 parts by weight, specifically 1-5 parts by weight. If the content is less than 1 part by weight, the lowering of cholesterol may be limited and meat may not be tenderized. And, if it exceeds 10 parts by weight, the taste of the meat may be poor due to strong bitter state.

The meat aging composition of the present disclosure may be used for any meat, including pork, beef, chicken meat and duck meat, without particular limitation.

The present disclosure also provides a meat aging method using the meat aging composition.

The meat aging method of the present disclosure comprises: preparing a meat aging composition by mixing 1-25 wt % of a Cudrania tricuspidata bark hot water extract, 10-30 wt % of a Cudrania tricuspidata leaf hot water extract and 20-60 wt % of a Cudrania tricuspidata fruit hot water extract and allowing the mixture to stand for 3-5 hours; and performing aging at −1 to 5° C. for 24-48 hours by mixing the meat aging composition and meat with a volume ratio of 1:1 to 1:3.

The meat aging method may further comprise steaming and drying Cudrania tricuspidata bark, Cudrania tricuspidata leaves and Cudrania tricuspidata fruit nine times, washing the Cudrania tricuspidata bark, Cudrania tricuspidata leaves and Cudrania tricuspidata fruit steamed and dried nine times with distilled water and then pulverizing, before said preparing the meat aging composition, and may further comprise performing aging by adding chitosan and onion.

First, Cudrania tricuspidata bark, Cudrania tricuspidata leaves and Cudrania tricuspidata fruit may be steamed at 70-90° C. for 10-15 hours and dried at 23-26° C. for 35-40 hours nine times to obtain Cudrania tricuspidata bark, leaves and fruit steamed and at nine times.

If the steaming is performed below 70° C. and/or for less than 10 hours, prevention of obesity, tenderization of meat and improvement of taste may not be achieved. And, if the steaming is performed above 90° C. and/or for longer than 15 hours, active ingredients may be broken down. If the drying is performed below 23° C. and/or for less than 35 hours, the content of the active ingredients may not increase in the following steaming processes. If the drying is performed above 26° C., the active ingredients may decrease. And, if the drying time exceeds 40 hours, a long time may be required for extraction.

Next, the Cudrania tricuspidata bark, leaves and fruit steamed and dried nine times are washed with distilled water and then pulverized. The particle size of the pulverized Cudrania tricuspidata bark, leaves and fruit is not particularly limited as long as extraction can be achieved easily. Specifically, it may be 1-3 cm.

Next, the pulverized Cudrania tricuspidata bark, leaves and fruit are respectively heated in hot water of 100-130° C. for 1-3 hours to obtain hot water extracts. If the extraction temperature is below 100° C., a long time is required for the extraction. And, if the temperature is above 130° C., the effect of meat tenderization, obesity prevention, etc. may not be achieved owing to the change in composition and the taste of the meat may be poor. If the extraction time is shorter than 1 hour, it is difficult to obtain a desired amount of extract. And, if the extraction time exceeds 3 hours, the meat may not be tenderized enough and taste may be poor owing to impurities.

The Cudrania tricuspidata fruit extract may also be prepared by squeezing.

Next, 1-25 wt % of the Cudrania tricuspidata bark extract, 10-30 wt % of the Cudrania tricuspidata leaf extract and 20-60 wt % of the Cudrania tricuspidata fruit extract are mixed and allowed to stand at room temperature for 3-5 hours, specifically 3-4 hours, to obtain the meat aging composition.

The composition obtained by mixing the Cudrania tricuspidata bark extract, the Cudrania tricuspidata leaf extract and the Cudrania tricuspidata fruit extract and allowing the mixture to stand at room temperature has further improved effect of meat tenderizing, taste improvement and cholesterol lowering owing to the synergic interactions of the active ingredients of the extracts. If the time during which the mixture is allowed to stand is below 3 hours, the meat may be less soft after aging. And, if the time exceeds 5 hours, the taste of meat may be poor.

A fermented broth of shiitake and licorice may be added to the meat aging composition. If the extracts are mixed with the fermented broth of shiitake and licorice, licorice helps mixing of the fermented broth with the extracts and the effect of meat tenderizing, taste improvement and cholesterol lowering is further improved.

Next, meat is aged at −1 to 5° C. for 24-48 hours by mixing the meat aging composition and the meat with a volume ratio of 1:1 to 1:3. If the volume ratio of the meat aging composition and the meat is below 1:1, the meat may not be tenderized enough. And, if the volume ratio exceeds 1:3, the meat may become tough. If the aging at the low temperature is performed for less than 24 hours, the taste of the meat may not be improved. And, if the aging time exceeds 48 hours, the meat may become tough and less tasty.

Next, the aged meat is aged further at −1 to 5° C. for 1-4 hours by adding 1-10 parts by weight of chitosan and 1-10 parts by weight of onion based on 100 parts by weight of the meat aging composition. If the aging at the low temperature is performed for less than 1 hour, chitosan may not permeate the meat. And, if the aging time exceeds 4 hours, the meat may become less tasty owing to the bitter taste of onion.

Although the meat may also be aged by mixing the fermented broth of shiitake, the Cudrania tricuspidata bark extract, the Cudrania tricuspidata leaf extract, the Cudrania tricuspidata fruit extract, chitosan and onion at once, the aging may be carried out in two stages as described above for improvement of taste, flavor and chewiness of the meat.

When the meat aging composition comprising the Cudrania tricuspidata bark extract, the Cudrania tricuspidata leaf extract and the Cudrania tricuspidata fruit extract is used, the meat may decay slowly in addition to the various effects of meat tenderization, cholesterol lowering, obesity prevention, hangover cure, improvement of taste, flavor and chewiness, or the like.

### EXAMPLES

Hereinafter, the present disclosure will be described in further detail through examples. However, the following examples are provided for illustrative purposes only and it will be apparent to those skilled in the art that various changes and modifications may be made within the scope of the present disclosure.

### Preparation Example 1

### Preparation of Cudrania tricuspidata Bark, Leaf and Fruit Extracts

Cudrania tricuspidata bark, leaf and fruit were respectively pulverized to a particle size of 1 cm. Each of the pulverized Cudrania tricuspidata bark, leaf and fruit was heated in hot water of 130° C. for 3 hours to obtain an extract.

### Preparation Example 2

### Preparation of Extracts of Cudrania tricuspidata Bark, Leaf and Fruit Steamed and Dried Nine Times

Each of Cudrania tricuspidata bark, leaf and fruit was steamed at 80° C. for 12 hours and dried at 26° C. for 38 hours nine times. Thus obtained Cudrania tricuspidata bark, leaf and fruit steamed and dried nine times were respectively cut to a particle size of particle size of 1 cm. Each of the pulverized Cudrania tricuspidata bark, leaf and fruit was heated in hot water of 130° C. for 3 hours to obtain an extract.

### Preparation Example 3

### Preparation of Fermented Broth of Shiitake

20 wt % of shiitake, 15 wt % of brown sugar, 3 wt % of Bacillus subtilis and 62 wt % of purified water were mixed. After performing fermentation at 50° C. for 50 hours, 3 parts by weight of Acetobacter aceti was added based on 100 parts by weight of the fermented broth. A fermented broth of shiitake was prepared by performing fermentation at 30° C. for 25 days.

### Example 1

A meat aging composition was prepared by mixing 25 wt % of the Cudrania tricuspidata bark extract, 25 wt % of the Cudrania tricuspidata leaf extract and 50 wt % of the Cudrania tricuspidata fruit extract prepared in Preparation Example 1. After allowing to stand for 5 hours, meat was aged at −1° C. for 48 hours by mixing the meat aging composition and the meat with a volume ratio of 1:1.

### Example 2

Meat was aged in the same manner as Example 1, except for using the extracts of the Cudrania tricuspidata bark, leaf and fruit steamed and dried nine times prepared in Preparation Example 2 instead of the Cudrania tricuspidata bark, leaf and fruit extracts prepared in Preparation Example 1.

### Example 3

Meat was aged in the same manner as Example 1 using a mixture of 24 wt % of the fermented broth of shiitake prepared in Preparation Example 3, 12 wt % of licorice and 16 wt % of the Cudrania tricuspidata bark extract, 16 wt % of the Cudrania tricuspidata leaf extract and 32 wt % of the Cudrania tricuspidata fruit extract prepared in Preparation Example 1 as a meat aging composition.

### Example 4

Meat was aged in the same manner as Example 1 by, after the aging, further aging the meat at −1° C. for 1 hour by adding 5 parts by weight of chitosan and 7 parts by weight of onion based on 100 parts by weight of the meat aging composition.

### Example 5

Meat was aged in the same manner as Example 3 by, after the aging, further aging the meat at −1° C. for 1 hour by adding 5 parts by weight of chitosan and 7 parts by weight of onion based on 100 parts by weight of the meat aging composition.

### Example 6

Meat was aged in the same manner as Example 1, except for using 25 wt % of the Cudrania tricuspidata bark extract, 50 wt % of the Cudrania tricuspidata leaf extract and 25 wt % of the Cudrania tricuspidata fruit extract prepared in Preparation Example 1.

### Comparative Example 1

Meat was aged in the same manner as Example 1 using 50 wt % of the Cudrania tricuspidata bark extract and 50 wt % of the Cudrania tricuspidata leaf extract without using the Cudrania tricuspidata fruit extract.

### Comparative Example 2

Meat was aged in the same manner as Example 1 using 30 wt % of the Cudrania tricuspidata bark extract and 70 wt % of the Cudrania tricuspidata fruit extract without using the Cudrania tricuspidata leaf extract.

### Comparative Example 3

Meat was aged in the same manner as Example 1 using 30 wt % of the Cudrania tricuspidata leaf extract and 70 wt % of the Cudrania tricuspidata fruit extract without using the Cudrania tricuspidata bark extract.

### Test Example 1

1. Cholesterol level (mL/dL): 50 g of the meat prepared in Examples 1-6 or Comparative Examples 1-3 was given to male Sprague Dawley rat (200 g) for 7 days (\textcircled{1}). For the following 30 days, the experimental animal was given the same diet before the meat was given. Then, 50 g of not aged, normal meat was given for 7 days (\textcircled{2}). Thereafter, 20 mL of blood was taken from the jugular vein using Vacutainer® (Becton Dickinson, Franklin Lakes, N.J., USA) and dispensed into two heparin-untreated tubes, 10 mL each. After slightly shaking up and down and waiting for about 2 hours, the coagulated blood was centrifuged at 4° C. and at 3,000 rpm for 15 minutes. After removing serum, the remainder was shaken well and total cholesterol level was measured using an automated hematology analyzer (Hema Vet 950, USA).

2. Storage property: The meat prepared in Examples 1-6 or Comparative Examples 1-3 was wrapped with vinyl wrap and, while storing in a refrigerator (2±1° C.), thiobarbituric acid reactive substances (TBARS) and volatile basic nitrogen (VBN) were measured on days 0, 3, 6 and 9.

(1) TBARS: According to Witte et al.'s method (1970), 10 g of meat was homogenized (14,000 rpm, 2 min) after adding 25 mL of 20% trichloroacetic acid (in 2 M phosphoric acid). After adjusting to 100 mL by adding distilled water, the mixture was stirred with a glass rod and then filtered through filter paper (Whatman No. 1). 5 mL of the filtrate was reacted with 5 mL of 0.05 M 2-thiobarbituric acid solution in a test tube. After keeping at room temperature in the dark for 15 hours, absorbance was measured at 530 nm using a UV-Vis spectrophotometer (UV-9100, HUMAN, USA). Then, TBARS was calculated according to Equation 1.

TBARS(mg of malonaldehyde/kg of sample)=absorbance at 530 nm×5.3 Equation 1

(2) VBN: 10 g of meat was mixed with 90 mL of distilled water and homogenized at 14,000 rpm for 5 minutes using a homogenizer (T25, Dong Yang Chemical). After filtering through filter paper (Whatman No. 1), 3 mL of the filtrate was put in the outer chamber of a Conway unit. After injecting 1 mL of 0.01 N boric acid into the inner chamber and injecting 1 mL of Conway reagent (0.066% methyl red:Bromocresol green/EtOH=1:1) into the outer chamber, the Conway unit was sealed immediately (For blank test, 50% potassium carbonate solution was not injected into the outer chamber.). After reciprocally shaking the Conway unit, followed by allowing to stand at 35° C. for 120 minutes, the boric acid in the inner chamber was titrated with 0.02 N H₂SO₄. VBN was determined according to Equation 2, wherein S (g) is the sample weight, b (mL) is the volume of added H₂SO₄ in blank, a (mL) is the volume of added H₂SO₄ in the sample and F is the standard factor of 0.02 N H₂SO₄.

VBN mg %(mg/100 g sample)=(a−b)×F(0.98)×28×100/S Equation 2

(F: standard factor of 0.02 N H₂SO₄=theoretical value, actual value 28=the amount of N necessary to consume 1 mL of 0.02 N H₂SO₄)

TABLE 1

| | | | | | | | Comp. | Comp. | Comp. | |
|---|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 | Control |
| Cholesterol | | | | | | | | | | |
| (mLdL/) | | | | | | | | | | |
| \textcircled{1} | 1.20 ± | 115.42 ± | 114.92 ± | 117.41 ± | 110.82 ± | 131.24 ± | 140.22 ± | 142.07 ± | 143.52 ± | — |
| | 7.23 | 7.01 | 6.93 | 7.54 | 7.23 | 2.83 | 6.83 | 6.53 | 7.02 | |
| \textcircled{2} | 150.42 ± | 151.11 ± | 150.11 ± | 149.72 ± | 150.42 ± | 150.12 ± | 150.72 ± | 151.42 ± | 150.93 ± | — |
| | 6.53 | 7.33 | 6.23 | 7.06 | 6.53 | 3.63 | 7.63 | 7.53 | 6.99 | |
| TBARS | | | | | | | | | | |
| Day 0 | 0.069 ± | 0.06 ± | 0.064 ± | 0.074 ± | 0.066 ± | 0.068 ± | 0.069 ± | 0.070 ± | 0.068 ± | 0.079 ± |
| | 0.002 | 0.002 | 0.003 | 0.002 | 0.002 | 0.002 | 0.002 | 0.002 | 0.002 | 0.412 |
| Day 3 | 0.194 ± | 0.194 ± | 0.174 ± | 0.186 ± | 0.121 ± | 0.211 ± | 0.216 ± | 0.201 ± | 0.199 ± | 0.278 ± |
| | 0.002 | 0.003 | 0.002 | 0.002 | 0.002 | 0.002 | 0.002 | 0.003 | 0.003 | 0.008 |
| Day 6 | 0.301 ± | 0.286 ± | 0.236 ± | 0.246 ± | 0.191 ± | 0.341 ± | 0.321 ± | 0.310 ± | 0.306 ± | 0.399 ± |
| | 0.004 | 0.002 | 0.003 | 0.002 | 0.004 | 0.002 | 0.002 | 0.004 | 0.002 | 0.063 |
| Day 9 | 0.361 ± | 0.336 ± | 0.292 ± | 0.319 ± | 0.271 ± | 0.392 ± | 0.482 ± | 0.456 ± | 0.431 ± | 0.514 ± |
| | 0.002 | 0.002 | 0.002 | 0.002 | 0.002 | 0.004 | 0.004 | 0.002 | 0.002 | 0.062 |
| VBN | | | | | | | | | | |
| Day 0 | 1.882 ± | 1.811 ± | 1.842 ± | 1.794 ± | 1.782 ± | 1.951 ± | 1.799 ± | 1.754 ± | 1.783 ± | 1.801 ± |
| | 0.035 | 0.095 | 0.075 | 0.075 | 0.035 | 0.144 | 0.175 | 0.095 | 0.062 | 0.025 |
| Day 3 | 16.852 ± | 17.001 ± | 16.134 ± | 16.912 ± | 15.052 ± | 17.649 ± | 19.122 ± | 20.041 ± | 20.141 ± | 23.156 ± |
| | 0.145 | 0.415 | 0.416 | 0.775 | 0.145 | 0.442 | 0.475 | 0.645 | 0.341 | 0.141 |
| Day 6 | 38.462 ± | 38.022 ± | 36.182 ± | 38.901 ± | 33.062 ± | 39.610 ± | 40.942 ± | 41.142 ± | 42.513 ± | 49.944 ± |
| | 0.735 | 0.675 | 0.435 | 0.475 | 0.735 | 0.442 | 0.975 | 0.525 | 0.675 | 0.297 |
| Day 9 | 41.522 ± | 41.901 ± | 41.702 ± | 43.512 ± | 38.022 ± | 53.147 ± | 59.125 ± | 58.801 ± | 57.991 ± | 61.375 ± |
| | 0.315 | 0.675 | 0.511 | 0.675 | 0.315 | 0.512 | 0.575 | 0.550 | 0.914 | 1.046 |

As seen from Table 1, the meat prepared in Examples 1-6 according to the present disclosure showed lower cholesterol level than normal meat. Also, the meat showed better storage property than that of Comparative Examples 1-3 or control (unaged meat).

### Test Example 2

### Sensory Test

The meat prepared in Examples 1-6 or Comparative Examples 1-3 was sliced to 5 mm thickness and roasted at 70-80° C. Ten trained sensory test panels were asked to score taste, chewiness, flavor and overall preference from 0 to 7 points and average was calculated.

TABLE 2

| | | | | | | | Comp. | Comp. | Comp. | |
|---|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 | Control |
| Taste | 6.0 | 6.1 | 6.0 | 6.0 | 6.7 | 5.4 | 3.6 | 5.9 | 5.1 | 3.9 |
| Chewiness | 5.9 | 6.0 | 6.1 | 6.4 | 6.8 | 5.1 | 4.2 | 4.5 | 4.7 | 3.1 |
| Flavor | 5.9 | 5.4 | 5.9 | 6.2 | 6.8 | 5.9 | 4.0 | 5.4 | 5.0 | 3.1 |
| Overall | 6.0 | 6.1 | 6.4 | 6.5 | 6.7 | 5.8 | 3.9 | 4.6 | 4.4 | 3.1 |
| preference | | | | | | | | | | |

As seen from Table 2, the meat prepared in Examples 1-6 according to the present disclosure were superior in taste, chewiness, flavor and overall preference to that of Comparative Examples 1-3, wherein one of the Cudrania tricuspidata extracts was not used, or control (unaged meat). The better chewiness means that the meat was better tenderized.

Accordingly, it was confirmed that superior taste, chewiness, flavor and overall preference can be achieved when all the three Cudrania tricuspidata extracts are used in the meat aging composition, as in Examples 1-6.

The meat aging composition of the present disclosure using Cudrania tricuspidata extracts improves taste and chewiness of meat by tenderizing the meat and removes stench of the meat and improves flavor owing to the characteristic flavor of Cudrania tricuspidata.

Also, the meat aging composition of the present disclosure lowers cholesterol and thus prevents obesity even.

Further, the meat aging composition of the present disclosure improves storage property of meat, thus preventing decay even when the meat is stored for more than 9 days.

In addition, since the meat aging composition of the present disclosure provides the effect of curing hangover and protecting the liver, it may cure hangover and protect the liver when meat is eaten with liquor.

While the present disclosure has been described with respect to the specific embodiments, it will be apparent to those skilled in the art that various changes and modifications may be made without departing from the spirit and scope of the disclosure as defined in the following claims.

1. A meat aging composition comprising 1-25 wt % of hot water extract of bark of Cudrania tricuspidata, 10-30 wt % of hot water extract of leaves of Cudrania tricuspidata and 20-60 wt % of hot water extract of fruits of Cudrania tricuspidata.

2. The meat aging composition according to claim 1, wherein the hot water extract of bark of Cudrania tricuspidata, the hot water extract of leaves of Cudrania tricuspidata and the hot water extract of fruits of Cudrania tricuspidata are mixed with a weight ratio of 1:1:2.

3. The meat aging composition according to claim 1, which further comprises 5-25 wt % of a fermented broth of shiitake and 1-20 wt % of licorice,
wherein the fermented broth of shiitake is obtained by fermenting using Bacillus subtilis and Acetobacter aceti.

4. The meat aging composition according to claim 1, which further comprises 1-10 parts by weight of chitosan and 1-10 parts by weight of onion based on 100 parts by weight of the meat aging composition.

5. The meat aging composition according to claim 1, wherein the hot water extract of bark of Cudrania tricuspidata, the hot water extract of leaves of Cudrania tricuspidata and the hot water extract of fruits of Cudrania tricuspidata are extracted respectively from bark of Cudrania tricuspidata, leaves of Cudrania tricuspidata and fruits of Cudrania tricuspidata, wherein the bark of Cudrania tricuspidata, leaves of Cudrania tricuspidata and fruits of Cudrania tricuspidata steamed and dried nine times.

7. A meat aging method comprising:
preparing a meat aging composition by mixing 1-25 wt % of hot water extract of bark of Cudrania tricuspidata, 10-30 wt % of hot water extract of leaves of Cudrania tricuspidata and 20-60 wt % of hot water extract of fruits of Cudrania tricuspidata and allowing the mixture to stand for 3-5 hours; and
performing aging at −1 to 5° C. for 24-48 hours by mixing the meat aging composition and meat with a volume ratio of 1:1 to 1:3.

8. The meat aging method according to claim 7, wherein the hot water extract of bark of Cudrania tricuspidata, the hot water extract of leaves of Cudrania tricuspidata and the hot water extract of fruits of Cudrania tricuspidata are mixed with a weight ratio of 1:1:2.

9. The meat aging method according to claim 7, wherein the meat aging composition further comprises 5-25 wt % of a fermented broth of shiitake and 1-20 wt % of licorice and the fermented broth of shiitake is obtained by fermenting using Bacillus subtilis and Acetobacter aceti.

10. The meat aging method according to claim 7, which further comprises, before said preparing the meat aging composition, steaming and drying bark, leaves and fruits of Cudrania tricuspidata nine times, washing the bark, leaves and fruits of Cudrania tricuspidata steamed and dried nine times with distilled water and then pulverizing, and heating the pulverized bark, leaves and fruits of Cudrania tricuspidata in hot water of 100-130° C. for 1-3 hours to obtain a hot water extract.

11. The meat aging method according to claim 7, which further comprises, after said aging, performing aging at −1 to 5° C. for 1-4 hours by adding 1-10 parts by weight of chitosan and 1-10 parts by weight of onion based on 100 parts by weight of the meat aging composition to the aged meat.

12. The meat aging method according to claim 9, wherein the fermented broth of shiitake is prepared by performing fermentation at 45-55° C. for 30-60 hours by mixing 10-30 wt % of shiitake, 5-20 wt % of brown sugar, 1-4 wt % of Bacillus subtilis and 60-70 wt % of purified water and performing fermentation at 25-35° C. for 20-40 days by adding 1-4 parts by weight of Acetobacter aceti based on 100 parts by weight of the fermented broth.
